(19) United States
(12) Patent Application Publication
(10) Pub. No.: US 2025/0100061 A1
(43) Pub. Date: Mar. 27, 2025

(54) ONE-SIDED SUBMERGED ARC WELDING METHOD, WELD JOINT, AND PRODUCTION METHOD FOR WELD JOINT

(71) Applicant: JFE STEEL CORPORATION, Tokyo (JP)

(72) Inventor: Akiyoshi ANDO, Tokyo (JP)

(73) Assignee: JFE STEEL CORPORATION, Tokyo (JP)

(21) Appl. No.: 18/730,558

(22) PCT Filed: Nov. 7, 2022
(86) PCT No.: PCT/JP2022/041369

§ 371 Date: Jul. 19, 2024

(30) Foreign Application Priority Data
Feb. 28, 2022 (JP) 2022-028909

(51) Int. Cl. B23K 9/18; F16B 5/08

(52) U.S. Cl. CPC B23K 9/18; F16B 5/08

(57) ABSTRACT

A highly productive submerged arc welding method ensuring excellent mechanical properties when welding thick steel plates at high heat inputs in the fields of shipbuilding, construction and so on; a weld joint produced using such welding method; and a production method for such weld joint. The welding method is a one-sided submerged arc welding method for welding two butted steel plates, in which grooves are formed on both a front and a back surface side of the steel plates, root faces are formed between the groove on the front surface side and the groove on the back surface side, and welding is performed from the front surface side. It is preferred that a root face height be 2 to 5 mm, and that a groove depth on the back surface side be 2 to 5 mm.

### TECHNICAL FIELD

The present invention relates to a one-sided submerged arc welding method capable of efficiently achieving excellent weld joint properties via a submerged arc welding process; a weld joint produced by such welding method; and a production method for such weld joint.

### BACKGROUND ART

Submerged arc welding (hereinafter also referred to as “SAW”) is used in a wide range of fields. For example, in the shipbuilding field, since plate joint welding is carried out in a tremendously large scale, the reversal procedure after welding is difficult, which has triggered one-sided welding methods to be used frequently where welding can be completed from one side and no reversal procedure is required thereby. While V groove and Y groove are used in a one-sided welding method, their groove depths and groove widths become larger as the plate thickness becomes larger, whereby the groove cross-sectional areas of these grooves become larger in proportion to the squares of the groove depths thereof. A larger groove cross-sectional area leads to an increase in weld metal required and also leads to a larger number of work steps.

In response to such problem, Patent Literature 1, for example, discloses a submerged arc welding method where welding is performed on one side and with one layer, using multiple electrodes. The method disclosed in Patent Literature 1 is such that the wire deposition amount is increased by employing specified conditions such as the polarity of the first electrode and the distance between the electrodes, whereby high-temperature cracking is less likely to occur, the front and back beads have favorable shapes, and slag inclusion can be reduced.

### CITATION LIST

### Patent Literature

Patent Literature 1: JP-A-2017-213569

### SUMMARY OF THE INVENTION

### Technical Problem

In the conventional one-sided welding technique, the groove cross-sectional area dramatically increased as the plate thickness increased, which inevitably resulted in a significantly larger number of work steps and a larger heat input for the purpose of reducing the number of work steps. Thus, there has been a problem that the low-temperature toughness of the weld heat-affected zone (also referred to as “HAZ”) will be notably impaired by an excessive heat input.

Specifically, as a groove used in one-sided welding, there is employed a Y-shaped groove shown in FIG. 2. The groove shape of such a Y-shaped groove is composed of root faces 3a, 3b for butting steel plates 1a, 1b on their lower surface side (back surface side); and tapered portions 2a, 2b that are provided on the upper portion of the steel plates (front surface side) and are processed to have a given groove angle (θ) therebetween. In the case of such a groove, with a root face height (length of root face in plate thickness direction) held constant, a groove depth (projected length of tapered portion in plate thickness direction) (h) and a groove width will become large as a plate thickness (t) becomes large. A groove cross-sectional area(S) increases in proportion to the square of the groove depth (h). A larger groove cross-sectional area(S) requires a larger amount of welding material supplied from the wire. Therefore, in terms of keeping a constant welding speed to maintain productivity, either the welding current or the number of electrodes need to be increased to improve the wire supply rate.

However, a method with an increased welding current or a larger number of electrodes will lead to an increased welding heat input and a reduced cooling speed. A reduced cooling speed means that the weld heat-affected zone will be exposed to a high temperature for a longer period of time. As a result, the crystal grains will coarsen, which causes a problem that mechanical properties will deteriorate significantly. Further, additional power-supply devices may be needed depending on the current employed and the number of electrodes; the cost, installation spaces and so on of these devices can be problematic.

Meanwhile, there is also a method of reducing the groove cross-sectional area(S) by narrowing the groove angle (θ). However, as a result of narrowing the groove angle (θ), arc will be generated in the upper region inside the groove, which will lead to an incomplete penetration in the root face part. Further, if employing larger root faces to form a shallow groove, the root faces cannot be melted completely with the arc force, which makes it impossible to form the type of penetration that is required in one-sided welding.

Even in Patent Literature 1, in which the amount of weld metal required for one layer is supplied from the welding wire, a high current is required, leading to an extremely large heat input per unit weld length. The problem with multi-electrode welding is that as the welding heat input increases, the cooling speed after welding will drop intensely, which causes the weld heat-affected zone to be exposed to a high temperature for a long period of time, whereby the crystal grains will coarsen to deteriorate mechanical properties.

The present invention was made in view of the above problems, and it is an object of the present invention to provide a highly productive one-sided submerged arc welding method ensuring excellent mechanical properties when welding thick steel plates at high heat inputs especially in the fields of shipbuilding, construction and so on; a weld joint produced using such welding method; and a production method for such weld joint.

### Solution to Problem

In order to achieve the abovementioned object, the inventors of the present invention diligently conducted studies on an appropriate groove shape capable of reducing the amount of deposit metal required. As a result, the inventors made the following findings. That is, by downsizing the groove as a result of reducing the groove depth on the front surface side, the root faces will be moved toward the front surface side, and a tiny groove can then be provided even on the back surface side, thereby making groove butting for weld preparation easy and allowing a favorable penetration to be formed even on the back surface side while melting the root faces with a minimum heat input required.

The present invention was completed based on these findings and further studies; the gist of the present invention is as follows.

[1] A one-sided submerged arc welding method for welding two butted steel plates, in which grooves are formed on both a front and a back surface side of the steel plates, root faces are formed between the groove on the front surface side and the groove on the back surface side, and welding is performed from the front surface side.

[2] The one-sided submerged arc welding method according to [1], wherein the root faces each have a height of 2 to 5 mm.

[3] The one-sided submerged arc welding method according to [1] or [2], wherein the groove on the back surface side has a groove depth of 2 to 5 mm.

[4] The one-sided submerged arc welding method according to any one of [1] to [3], wherein groove angles on both the front surface side and the back surface side are each 20 to 70° [5] The one-sided submerged arc welding method according to any one of [1] to [4], wherein the steel plates each have a plate thickness of 9 to 40 mm.

[6] The one-sided submerged arc welding method according to any one of [1] to [5], wherein a welding speed is 500 to 1,200 mm/min.

[7] The one-sided submerged arc welding method according to any one of [1] to [6], wherein two to four electrodes are used.

[8] The one-sided submerged arc welding method according to [7], wherein a current value of a first electrode in the electrodes is 700 to 1,600 A.

[9] The one-sided submerged arc welding method according to [7] or [8], wherein a total welding heat input of all the electrodes is 20,000 J/mm or smaller.

[10] The one-sided submerged arc welding method according to any one of [1] to [9], wherein the welding on the front surface side is performed with one or more layers.

[11] A weld joint produced by the welding method according to any one of [1] to [10].

[12] A production method for a weld joint, in which a weld joint is formed by performing jointing via the welding method according to any one of [1] to [10].

### Advantageous Effects of Invention

With the one-sided submerged arc welding method, the weld joint, and the production method thereof that are proposed by the present invention, there can be provided a welding method capable of obtaining, with a high efficiency, a weld metal having a high strength and an excellent low-temperature toughness. Thus, the present invention brings about industrially exceptional effects because a weld joint can be produced efficiently, and because the invention has a high productivity and is capable of ensuring excellent mechanical properties when welding thick steel plates at high heat inputs especially in the fields of shipbuilding, construction and so on.

### BRIEF DESCRIPTION OF DRAWINGS

FIG. 1 is a cross-sectional schematic diagram showing a groove shape suitable for use in a one-sided submerged arc welding method of an embodiment of the present invention.

FIG. 2 is a cross-sectional schematic diagram showing a groove shape used in a conventional one-sided submerged arc welding method.

FIG. 3 is a graph showing how groove shapes affect a correlation between the plate thickness of a steel plate and welding heat input in a one-sided submerged arc welding method.

FIG. 4 is a cross-sectional schematic diagram showing a site at which a specimen for the Charpy impact test is collected after performing one-sided submerged arc welding.

### DESCRIPTION OF EMBODIMENTS

An embodiment of the present invention is described in detail hereunder. Here, the accompanying drawings are schematic and may differ from the embodiment in reality. Further, the following embodiment is a set of examples of equipment and methods for embodying the technical concept of the present invention and is not to limit the configuration of the present invention to those shown below. That is, various modifications can be made to the technical concept of the present invention within the technical scope described in the claims.

### [Groove Shape]

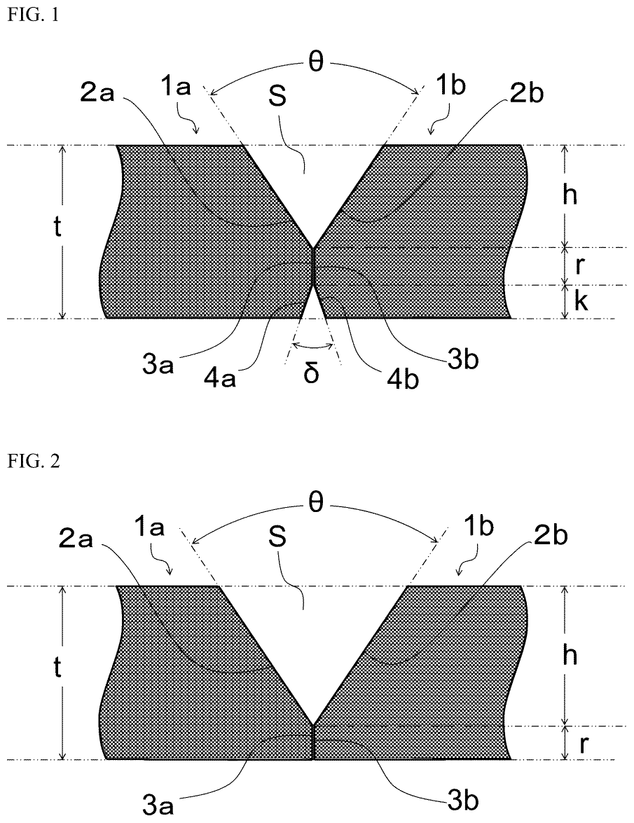

At first, FIG. 1 is used to describe a groove shape suitable for a one-sided submerged arc welding method of an embodiment of the present invention.

The groove shape of this embodiment is an X-shaped double groove having root faces 3a, 3b shown in FIG. 1. This groove is mainly of a shape where a groove is formed on the front surface side to which the weld metal is to be supplied, another groove is formed on the back surface side, and the root faces are provided between these two grooves.

Specifically, formed on the upper portion (front surface side) of steel plates 1a, 1b are front surface side tapered portions 2a, 2b that are processed to have a given groove angle (θ) therebetween. Formed on the lower portion (back surface side) of the steel plates 1a, 1b are back surface side tapered portions 4a, 4b that are processed to have a given groove angle (δ) therebetween. The root faces 3a, 3b for plate butting are formed between the front and the back surface side tapered portions of the steel plates.

Here, a depth (groove depth) h of the front surface side groove is defined as a projected length of the front surface side tapered portions 2a, 2b in the plate thickness direction. A depth (groove depth) k of the back surface side groove is defined as a projected length of the back surface side tapered portions 4a, 4b in the plate thickness direction. A height r of the root face (root face height) is defined as a length of each of the root faces 3a, 3b in the plate thickness direction. The root face height r is preferably 2 to 5 mm. If r is smaller than 2 mm, there may be a problem in plate butting for weld preparation which is caused by machining errors in the grooves. Meanwhile, if r is larger than 5 mm, a uniform penetration bead may not be formed as the root faces fail to melt completely. More preferably, r is in a range of 3 to 4 mm. Further, the back surface side groove depth k is preferably 2 to 5 mm. If k is smaller than 2 mm, an effect of reducing deposit metal may not be sufficiently achieved. Meanwhile, if k is larger than 5 mm, a uniform penetration shape may not be formed. More preferably, k is in a range of 3 to 4 mm. Here, a plate thickness t of the steel plate is preferably 9 to 40 mm. If t is smaller than 9 mm, welding can be satisfactorily carried out via conventional single-electrode submerged arc welding. Meanwhile, if t is larger than 40 mm, welding may not be completed in one pass even when using four electrodes. More preferably, t is in a range of 12 to 25 mm.

Moreover, the front surface side groove angle θ and the back surface side groove angle δ are preferably 20 to 70°, respectively. When the groove angles θ, δ are out of this range, a uniform penetration shape may not be formed. More preferably, the groove angles θ, δ are each in a range of 30 to 45°.

As a processing method for forming the above groove shape, there may be used, for example, a plasma cutting method and a gas cutting method. A laser cutting method and a machining method may be also used.

Here, the side that is subjected to one-sided submerged arc welding is the front surface side.

### [Submerged Arc Welding]

Described hereunder is a one-sided one-layer submerged arc welding (SAW) method of this embodiment that involves a butt joint.

SAW is a welding method in which an electrode wire is continuously supplied into a powdery flux that has been previously spread on the base metal, and an arc is generated between the tip of this electrode wire and the base metal to perform welding continuously. SAW has the advantage that welding can be performed efficiently by increasing the deposition rate of the wire via the application of a large current. There are employed single-electrode welding; or multi-electrode welding where welding efficiency is improved by arranging two to four electrodes in series depending on the plate thickness and groove shape of the material to be welded. Further, as an applied technology for performing one-sided one-layer welding, there has also been developed, for example, a so-called “flux copper backing” one-sided welding method which is a process where a backing flux is spread on a copper plate to optimize the penetration shape, and the copper plate is brought into close contact with the back surface of a steel plate by an air pressure from the back surface of the copper plate.

In this embodiment, a flux copper backing one-sided welding method using three electrodes is explained as one embodiment of SAW.

The two steel plates 1a and 1b are butted together to form a V groove with the aforementioned groove angle (θ) on the front surface side. As the three electrodes used there, the diameter of a welding wire used as a first electrode is preferably 4.0 to 4.8 mmφ, and the diameters of welding wires used as a second and a third electrode are preferably 4.8 to 6.4 mmφ. By making the diameters of the second and third electrodes larger than that of the first electrode, the welding penetration width can be widened. Further, it is preferred that a distance between the first and second electrodes be 30 to 50 mm. If the distance between the first and second electrodes is smaller than the lower limit, their arcs may interfere with each other and become unstable, whereby the bead shape may become irregular. Meanwhile, if the distance between the first and second electrodes is larger than the upper limit, an unstable penetration depth will be observed, which may result in a poor penetration formation. It is preferred that a distance between the second and third electrodes be 120 to 180 mm. Cracks are more likely to occur if the distance between the second and third electrodes is smaller than the lower limit. Meanwhile, slag inclusion is more likely to occur if the distance between the second and third electrodes is larger than the upper limit.

In this embodiment, a welding flux is then spread in the grooves on the front and the back surface side, followed by performing one-sided one-layer welding in a flat position without preheating.

Here, one-sided multi-layer welding may also be performed with the grooves being formed into the shapes of this embodiment. Particularly, if the plate thickness t is larger than 40 mm, it is difficult to finish welding with one layer. In such a case, a significant improvement in operation efficiency can be expected by performing one-sided multi-layer welding and applying the welding method of this embodiment to the first layer.

The welding current (AC) of the first electrode is preferably 700 to 1,600 A. More preferably, the welding current of the first electrode is 900 to 1,300 A. The welding voltage of the first electrode is preferably 25 to 40 V. More preferably, the welding voltage of the first electrode is 28 to 35 V. The welding current (AC) of the second electrode is preferably 800 to 1,500 A. More preferably, the welding current of the second electrode is 900 to 1,300 A. The welding voltage of the second electrode is preferably 28 to 45 V. More preferably, the welding voltage of the second electrode is 30 to 40 V. The welding current (AC) of the third electrode is preferably 600 to 1,300 A. More preferably, the welding current of the third electrode is 800 to 1,100 A. The welding voltage of the third electrode is preferably 30 to 50 V. More preferably, the welding voltage of the third electrode is 35 to 45 V. In the case of a preceding electrode, by employing a higher current and a lower voltage, the root faces 3a, 3b can be melted deeply and stably. As for a subsequent electrode, by setting the voltage higher, the bead width widens such that a stable bead shape can be achieved on the front surface.

The welding speed is preferably 500 to 1,200 mm/min. A welding speed less than 500 mm/min may result in an impaired productivity. Meanwhile, a welding speed more than 1,200 mm/min will make welding susceptible to disturbances caused by, for example, machining errors of the groove shapes and welding deformation, which may lead to a deteriorated welding quality. More preferably, the welding speed is 600 to 900 mm/min.

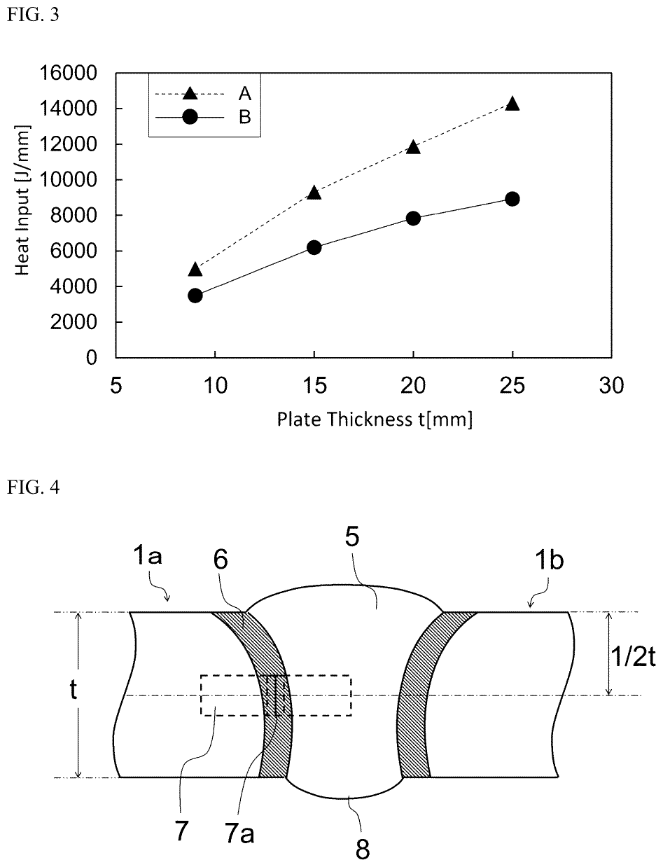

Here, a correlation between the plate thickness of the steel plate (base metal) and welding heat input is explained. FIG. 3 shows how groove shapes affect the correlation between the plate thickness t of the steel plate and welding heat input in the one-sided submerged arc welding method. Invention examples (symbol B) are such that grooves are provided on both the front and the back surface side as shown in FIG. 1. Conventional examples (symbol A) are such that a groove is only provided on the front surface side as shown in FIG. 2. As can be seen from the results shown in FIG. 3, the invention examples exhibited smaller welding heat inputs even with same plate thicknesses, as compared to the conventional examples. It is generally known that toughness improves when heat input is reduced for steel materials with a same plate thickness. It can be said that by applying this embodiment, the degradation in low-temperature toughness in the HAZ which is caused by an excessive heat input can be suppressed. Further, in this regard, it is preferred that a total welding heat input of all the electrodes be 20,000 J/mm or less in this embodiment.

In this embodiment, under the abovementioned welding conditions, the steel plates as base metals are butted together, and a weld joint is then formed using a welding wire and a welding flux that are described hereunder.

### [Welding Wire]

One example of the welding wire used in this embodiment is a solid wire as a welding material for steel for low temperature use. The ingredient composition thereof may be, for example, that of a steel having, in mass %, 0.10% C, 0.03% Si, 1.65% Mn, 2.40% Ni, 0.50% Mo, and a balance consisting of Fe and inevitable impurities. However, in this embodiment, the welding wire is not limited to such welding wire.

### [Welding Flux]

Any commonly known molten flux or bond flux may be used as the welding flux. As an example of the ingredient composition of a bond flux, there may be used a flux containing, for example, 10 to 30% SiO₂, 10 to 50% CaO, 20 to 50% MgO, 10 to 30% Al₂O₃, 5 to 20% CaF₂, and 2 to 15% CaCO₃. However, in this embodiment, the welding flux is not limited to such flux. Here, if using a bond flux, it is preferred that the bond flux be dried (e.g., at 200 to 300° C. for 1 to 2 hours) before welding as is the case with conventional SAW.

### EXAMPLES

### [Welding Conditions]

The present invention is described hereunder with reference to examples. However, the examples shown below are merely presented to explain the present invention in greater detail via examples and shall not limit the scope of claims of the present invention.

As a welding method, there was employed a flux copper backing one-sided welding method in which welding is performed with a copper plate that has been sprayed with a backing flux being pressed against the back surface of a steel plate. Without preheating and in a flat position, one-sided one-layer submerged arc welding was conducted under the various welding conditions shown in Table 1, using a solid wire (diameters 4.8 mm and 6.4 mm) as a welding material and two or three electrodes.

TABLE 1

| Welding | First electrode | | | Second electrode | | | Third electrode | | | Welding | Welding |
|---|---|---|---|---|---|---|---|---|---|---|---|
| condition | Current | Voltage | Polarity | Current | Voltage | Polarity | Current | Voltage | Polarity | speed | heat input |
| No. | A | V | — | A | V | — | A | V | — | mm/min | J/mm |
| 1 | 1200 | 30 | AC | 1100 | 35 | AC | — | — | — | 700 | 6390 |
| 2 | 1200 | 30 | AC | 1100 | 35 | AC | 950 | 40 | AC | 700 | 9640 |
| 3 | 1300 | 32 | AC | 1200 | 35 | AC | — | — | — | 550 | 9120 |
| 4 | 1300 | 32 | AC | 1200 | 35 | AC | 1100 | 45 | AC | 550 | 14520 |

### [Mechanical Properties of Weld Joint]

In accordance with the requirement stipulated in JIS Z 3111:2005 (Methods of tension and impact tests for deposited metal), a Charpy impact test specimen (V notch) shown in FIG. 4 was collected from a butt weld joint portion obtained via the above SAW, and an impact test was conducted.

FIG. 4 is a schematic diagram showing a collection site of the specimen for the Charpy impact test. As a result of performing one-sided one-layer SAW with the steel plates 1a and 1b being butted together, a weld metal 5 was formed in the groove portion on the front surface side, a penetration 8 was formed in the groove portion on the back surface side, and a weld heat-affected zone 6 was formed between the weld metal 5 and the steel plates. As for a specimen 7 (broken lines), the Charpy V-notch specimen 7 with a V notch 7a formed thereon was collected from the site of the weld heat-affected zone 6 which was at a depth of ½t of the plate thickness (t) of the steel plate, in accordance with JIS Z 2242:2018 (Method for Charpy impact test of metallic materials).

The Charpy impact test was conducted in such a way that there were prepared three specimens 7 that were each collected in the above manner, absorbed energies (ᵥE₋₆₀) at a test temperature of −60° C. were obtained, and an average value thereof was then defined as a value of low-temperature impact toughness of the weld heat-affected zone in each weld joint.

Further, penetration shape was evaluated in such a manner where a penetration was graded as a favorable penetration (Excellent) when the penetration 8 exhibited a bead width of 5.0 mm or larger and a bead height of 1.0 to 2.5 mm without showing undercuts, whereas penetrations that did not meet these criteria were graded as unfavorable penetrations (Poor).

Bead appearance was evaluated by visually observing the bead shape on the front surface side. The bead shape was graded as favorable (Excellent) when it was in a favorable condition with a uniform height and width, whereas the bead shape was graded as unfavorable (Poor) when it was nonuniform or exhibited undercuts.

The results obtained are shown in Table 2.

TABLE 2

| | | | | Groove shape | | | | | | | | |
|---|---|---|---|---|---|---|---|---|---|---|---|---|
| | | Welding | Number | Front surface side | | Root | Back surface side | | | | | |
| | Plate | condition | of | Groove | Groove | height | Groove | Groove | | Evaluation results | | |
| Joint | thickness | No. | electrode | depth h | angle θ | r | depth k | angle δ | Penetration | Bead | _{V}E₋₆₀ | |
| No. | mm | [Table 1] | — | mm | ° | mm | mm | ° | shape | appearance | J | Remarks |
| A | 16 | 1 | 2 | 10 | 50 | 3 | 3 | 30 | Excellent | Excellent | 72 | Invention Example |
| B | 16 | 1 | 2 | 10 | 60 | 3 | 3 | 40 | Excellent | Excellent | 71 | Invention Example |
| C | 16 | 1 | 2 | 10 | 70 | 4 | 2 | 60 | Excellent | Excellent | 89 | Invention Example |
| D | 16 | 1 | 2 | 9 | 50 | 3 | 4 | 20 | Excellent | Excellent | 94 | Invention Example |
| E | 25 | 3 | 2 | 18 | 60 | 4 | 3 | 30 | Excellent | Excellent | 88 | Invention Example |
| F | 25 | 3 | 2 | 17 | 60 | 4 | 4 | 20 | Excellent | Excellent | 86 | Invention Example |
| G | 25 | 3 | 2 | 18 | 70 | 5 | 2 | 50 | Excellent | Excellent | 56 | Invention Example |
| H | 25 | 3 | 2 | 17 | 60 | 5 | 3 | 30 | Excellent | Excellent | 64 | Invention Example |
| I | 16 | 1 | 2 | 13 | 50 | 3 | — | — | Excellent | Poor | 69 | Comparative Example |
| J | 16 | 2 | 3 | 13 | 50 | 3 | — | — | Excellent | Excellent | 15 | Comparative Example |
| K | 16 | 2 | 3 | 10 | 50 | 6 | — | — | Poor | Excellent | 22 | Comparative Example |
| L | 16 | 1 | 2 | 9 | 50 | 3 | 4 | 100 | Poor | Excellent | 70 | Comparative Example |
| M | 25 | 3 | 2 | 20 | 45 | 5 | — | — | Excellent | Poor | 80 | Comparative Example |
| N | 25 | 3 | 2 | 18 | 50 | 7 | — | — | Poor | Excellent | 66 | Comparative Example |
| O | 25 | 4 | 3 | 18 | 50 | 7 | — | — | Poor | Excellent | 19 | Comparative Example |
| P | 25 | 4 | 3 | 21 | 45 | 4 | — | — | Excellent | Excellent | 22 | Comparative Example |

In the cases of the weld joints listed as invention examples under the remarks column of Table 2, welding was able to be performed at a heat input of 6,390 J/mm with regard to joints involving a plate thickness of 16 mm (joints No. A to D). Similarly, welding was able to be performed at a heat input of 9,120 J/mm with regard to joints involving a plate thickness of 25 mm (joints No. E to H).

The joints No. A to H are each of a shape having a groove on the front and the back surface side; the joints No. A to H each exhibited a favorable bead appearance and penetration shape even after performing SAW at a large heat input. Moreover, it became clear that these joints were weld joints capable of achieving weld heat-affected zones having both a high strength and an excellent low-temperature toughness, as indicated by the fact that the absorbed energies (ᵥE₋₆₀) in the Charpy impact test at the test temperature of −60° C. were each 27 J or higher.

In contrast, in the cases of the weld joints (joints No. I to P) listed as comparative examples under the remarks column of Table 2, at least one of bead appearance, penetration shape, and absorbed energy (ᵥE₋₆₀) in the Charpy impact test at the test temperature of −60° C. did not meet the criteria. Thus, it was impossible to achieve a weld heat-affected zone having a desired weld shape, strength, and low-temperature toughness. Each comparative example is described below. Here, the groove shapes in the comparative examples were such that of the joints No. I to P, all joints except the joint No. L employed a Y-shaped groove (also referred to as “Y groove” hereinafter) with no groove formed on the back surface side as shown in FIG. 2.

As for the joint No. I, a Y groove was employed, and the groove had a larger cross-sectional area due to the large groove depth h of 13 mm with respect to the plate thickness t of 16 mm, which resulted in a shortage of the wire supplied under the welding condition (two electrodes) with a reduced heat input. For this reason, the groove was unable to be sufficiently filled with the weld metal, and an unfavorable bead appearance was observed.

As for the joint No. J, a Y groove was employed, and since welding was performed with three electrodes as is the case with conventional welding, an excessive heat input was incurred such that the absorbed energy (ᵥE₋₆₀) was 15 J (<27 J), which resulted in an impaired low-temperature toughness of the weld heat-affected zone.

As for the joint No. K, a Y groove was employed, and since welding was performed with three electrodes as is the case with conventional welding, an excessive heat input was incurred such that the absorbed energy (ᵥE₋₆₀) was 22 J (<27 J), which resulted in an impaired low-temperature toughness of the weld heat-affected zone. Further, since a large root face height r of 6 mm was employed, an incomplete penetration was observed with the root faces, making it impossible to form penetration.

As for the joint No. L, although there was employed a shape with grooves formed on both the front and the back surface side as are the cases with the invention examples, the groove angle δ on the back surface side was 100° which was beyond the preferable range of the present invention, and the bead shape on the back surface side was uneven such that undercuts were observed.

As for the joint No. M, a Y groove was employed, and the groove had a larger cross-sectional area due to the large groove depth h of 20 mm with respect to the plate thickness t of 25 mm, which resulted in a shortage of the wire supplied under the welding condition (two electrodes) with a reduced heat input. For this reason, the groove was unable to be sufficiently filled with the weld metal, and an unfavorable bead appearance was observed.

As for the joint No. N, a Y groove was employed, and since a large root face height r of 7 mm was employed, an incomplete penetration was observed with the root faces, making it impossible to form penetration.

As for the joint No. O, a Y groove was employed, and since welding was performed with three electrodes as is the case with conventional welding, an excessive heat input was incurred such that the absorbed energy (ᵥE₋₆₀) was 19 J (<27 J), which resulted in an impaired low-temperature toughness of the weld heat-affected zone. Further, since a large root face height r of 7 mm was employed, an incomplete penetration was observed with the root faces, making it impossible to form penetration.

As for the joint No. P, a Y groove was employed, and since welding was performed with three electrodes as is the case with conventional welding, an excessive heat input was incurred such that the absorbed energy (ᵥE₋₆₀) was 22 J (<27 J), which resulted in an impaired low-temperature toughness of the weld heat-affected zone.

### REFERENCE SIGNS LIST

1a, 1b Steel plate
2a, 2b (Front surface side) tapered portion
3a, 3b Root face
4a, 4b Back surface side tapered portion
5 Weld metal
6 Weld heat-affected zone (HAZ)
7 Specimen
7a V notch (site)
8 Penetration
h Groove depth (of front surface side groove)
k Groove depth (of back surface side groove)
r Root face height
S Groove cross-sectional area (front surface side)
θ (Front surface side) groove angle
δ (Back surface side) groove angle

1. A one-sided submerged arc welding method for welding two butted steel plates, in which grooves are formed on both a front and a back surface side of the steel plates, root faces are formed between the groove on the front surface side and the groove on the back surface side, and welding is performed from the front surface side.

2. The one-sided submerged arc welding method according to claim 1, wherein the root faces each have a height of 2 to 5 mm.

3. The one-sided submerged arc welding method according to claim 1, wherein the groove on the back surface side has a groove depth of 2 to 5 mm.

4. The one-sided submerged arc welding method according to claim 1, wherein groove angles on both the front and the back surface side are each 20 to 70°.

5. The one-sided submerged arc welding method according to claim 1, wherein the steel plates each have a plate thickness of 9 to 40 mm.

6. The one-sided submerged arc welding method according to claim 1, wherein a welding speed is 500 to 1,200 mm/min.

7. The one-sided submerged arc welding method according to claim 1, wherein two to four electrodes are used.

8. The one-sided submerged arc welding method according to claim 7, wherein a current value of a first electrode in the electrodes is 700 to 1,600 A.

9. The one-sided submerged arc welding method according to claim 7, wherein a total welding heat input of all the electrodes is 20,000 J/mm or smaller.

10. The one-sided submerged arc welding method according to claim 1, wherein the welding on the front surface side is performed with one or more layers.

11. A weld joint produced by the welding method according to claim 1.

12. A production method for a weld joint, in which a weld joint is formed by performing jointing via the welding method according to claim 1.
